(19) United States
(12) Patent Application Publication
(10) Pub. No.: US 2026/0024167 A1
(43) Pub. Date: Jan. 22, 2026

(54) IMAGE OUT-PAINTING METHOD AND IMAGE OUT-PAINTING SYSTEM

(71) Applicant: Acer Incorporated, New Taipei City (TW)

(72) Inventors: Chieh-Sheng WANG, New Taipei City (TW); Wen-Cheng HSU, New Taipei City (TW); Shih-Hao LIN, New Taipei City (TW); Chi-Kang LEE, New Taipei City (TW)

(73) Assignee: Acer Incorporated, New Taipei City (TW)

(21) Appl. No.: 19/208,033

(22) Filed: May 14, 2025

(30) Foreign Application Priority Data
Jul. 19, 2024 (TW) 113127178

(51) Int. Cl. G06T 5/50; G06T 3/40; G06T 5/70; G06T 5/77; G06T 7/13

(52) U.S. Cl. CPC G06T 5/50; G06T 3/40; G06T 5/70; G06T 5/77; G06T 7/13; G06T 2207/20132; G06T 2207/20221

(57) ABSTRACT

An image out-painting method and an image out-painting system are provided. The image out-painting method includes the following steps. An original image is provided. A ring block surrounding the original image is filled with a plurality of edge pixels of the original image to obtain a pre-processed image. The pre-processed image is cut into a plurality of to-be-processed images, each including a part of the original image and a part of the ring block. A plurality of masks are obtained according to the to-be-processed images. The contents of the ring block in the to-be-processed images are individually out-painted according to the masks to obtain a plurality of painted images. The painted images are stitched together to form an expanded image.

This application claims the benefit of Taiwan application Ser. No. 113127178, filed Jul. 19, 2024, the subject matter of which is incorporated herein by reference.

### BACKGROUND OF THE INVENTION

### Field of the Invention

The invention relates in general to an image painting method and an image painting system, and more particularly to an image out-painting method and an image out-painting system.

### Description of the Related Art

Along with the rapid development in the AI biographic model, the original image of any picture can be extended using AI biographic technology. This is the so-called out-painting.

However, the generation of high-resolution pictures using out-painting technology consumes a large volume of system resources. For instance, to execute a 1280×720 out-painting AI model, the computers must have the specifications of NVidia 2080 16GB, and this equipment is a great challenge to notebook computers.

### SUMMARY OF THE INVENTION

The invention is directed to an image out-painting method and an image out-painting system. During the image out-painting process, the original image is cut using pipeline technology then the cut images are processed with image out-painting to obtain several painted images, then the painted images are stitched together to form a large-sized expanded image. Since the process of obtaining several painted images does not occupy calculation resources and memory resources at the same time, most electronic devices will be able to out-paint large-sized images.

According to one embodiment of the present invention, an image out-painting method is provided. The image out-painting method includes the following steps. An original image is provided. A ring block surrounding the original image is filled with a plurality of edge pixels of the original image to obtain a pre-processed image. The pre-processed image is cut into a plurality of to-be-processed images, each including a part of the original image and a part of the ring block. A plurality of masks are obtained according to the to-be-processed images. The contents of the ring block in the to-be-processed images are individually out-painted according to the masks to obtain a plurality of painted images. The painted images are stitched together to form an expanded image.

According to another embodiment of the present invention, an image out-painting system is provided. The image out-painting system includes an input unit, a pre-processing unit, a cutting unit, a mask unit, an expansion unit and a stitching unit. The input unit is used to provide an original image. The pre-processing unit is used to fill a ring block surrounding the original image with a plurality of edge pixels of the original image to obtain a pre-processed image.

The cutting unit is used to cut the pre-processed image into a plurality of to-be-processed images, each including a part of the original image and a part of the ring block. The mask unit is used to obtain a plurality of masks according to the to-be-processed images. The expansion unit is used to individually out-paint the contents of the ring block in the to-be-processed images according to the masks to obtain a plurality of painted images. The stitching unit is used to stitch the painted images together to obtain an expanded image.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram exemplifying an image out-painting method according to an embodiment of the present disclosure.

FIG. 2 is a block diagram of an image out-painting system according to an embodiment of the present disclosure.

FIG. 3 is a flowchart of an image out-painting method according to an embodiment of the present disclosure.

FIG. 4 exemplifies each step of FIG. 3.

FIG. 5 exemplifies the relationship between the pre-processed image and the to-be-processed images.

FIG. 6 is another cutting method for the pre-processed image according to another embodiment.

### DETAILED DESCRIPTION OF THE INVENTION

Technical terms are used in the specification with reference to the prior art used in the technology field. For any terms described or defined in the specification, the descriptions and definitions in the specification shall prevail. Each embodiment of the present disclosure has one or more technical features. Given that each embodiment is implementable, a person ordinarily skilled in the art can selectively implement or combine some or all of the technical features of any embodiment of the present disclosure.

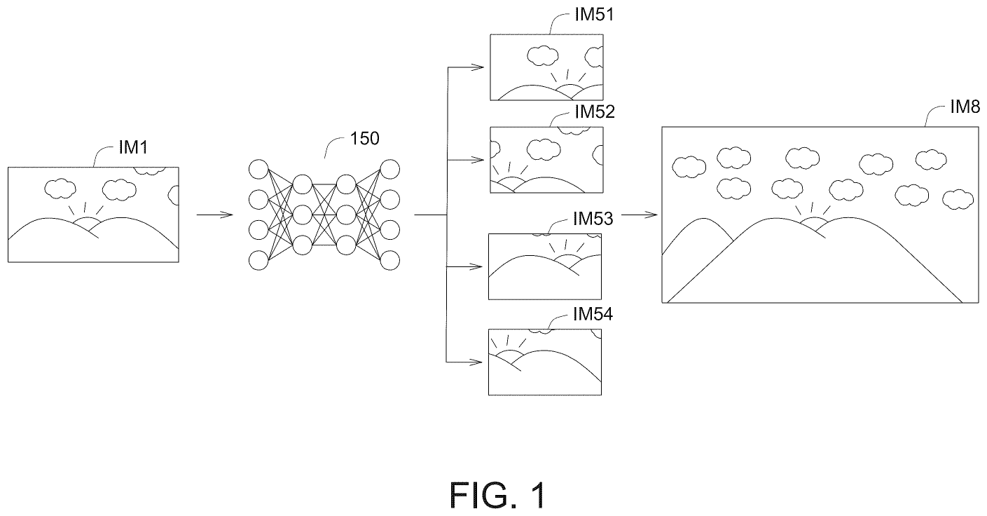

Referring to FIG. 1, a schematic diagram exemplifying an image out-painting method according to an embodiment of the present disclosure is shown. During the image out-painting process, the original image IM1 is cut using pipeline technology, then the expansion unit 150 out-paints the cut images to obtain several painted images IM51, IM52, IM53, IM54, then the painted images are stitched together to form a large-sized expanded image IM8.

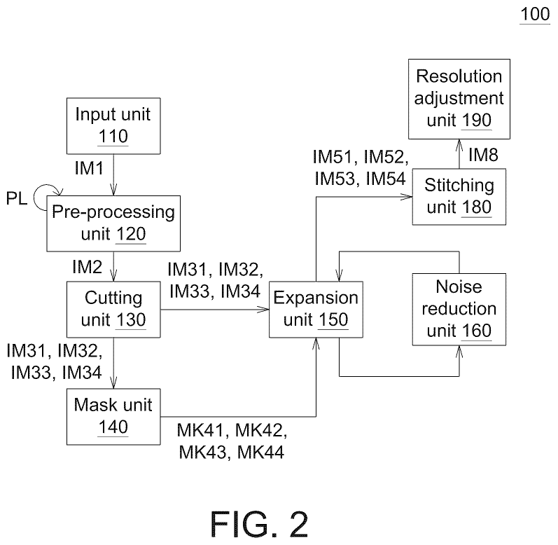

Referring to FIG. 2, a block diagram of an image out-painting system 100 according to an embodiment of the present disclosure is shown. The image out-painting system 100 can be realized by a laptop, a desktop, a mobile phone, a server or a cloud computing center. The image out-painting system 100 includes an input unit 110, a pre-processing unit 120, a cutting unit 130, a mask unit 140, an expansion unit 150, a noise reduction unit 160, a stitching unit 180 and a resolution adjustment unit 190. The input unit 110, used to input data, can be realized by a transmission port, a wireless network module or a wired network module. The pre-processing unit 120, the cutting unit 130, the mask unit 140, the expansion unit 150, the noise reduction unit 160, the stitching unit 180 and the resolution adjustment unit 190 are used to execute various calculation, analysis and processing procedures, and can be realized by a circuit, a circuit board, a storage device that stores program code or a chip. The chip can be realized by a central processing unit (CPU), or other programmable general-purpose or special-purpose micro control unit (MCU), a microprocessor, digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA) or other similar elements or a combination of the above elements.

During the image out-painting process, the image out-painting system 100 of the present embodiment cuts the original image IM1 into a plurality of to-be-processed images using pipeline technology, out-paints the to-be-processed images to obtain a plurality of out-painted images, then stitch the out-painted images to obtain a large-sized expanded image IM8. Details of the operations of each element are disclosed below with a flowchart.

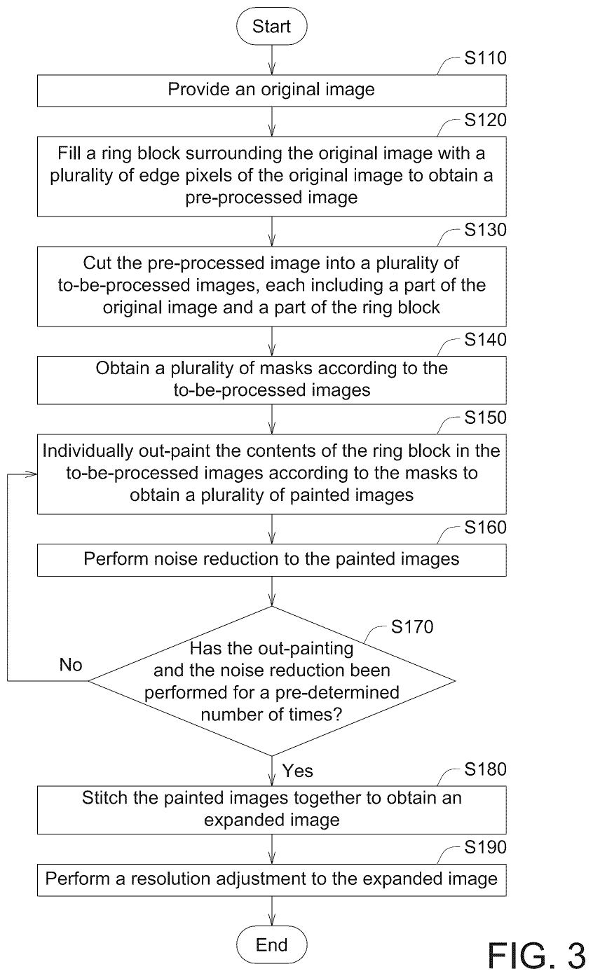

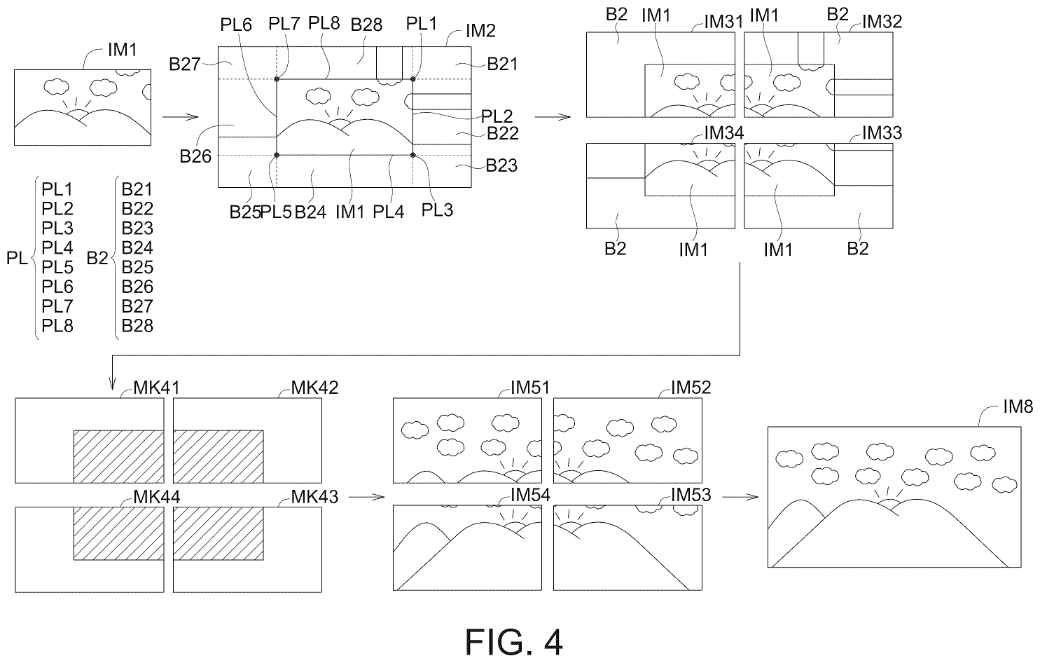

Refer to FIGS. 3 to 4. FIG. 3 is a flowchart of an image out-painting method according to an embodiment of the present disclosure. FIG. 4 exemplifies each step of FIG. 3. The image out-painting method includes step S110 to S190.

In step S110, as indicated in FIG. 4, an original image IM1 is provided by the input unit 110. The original image IM1 can be a photographed image, a hand-drawn image, or a computer tool-assisted drawing of an image. The original image IM1 can be accessed via a transport port or network or from a storage device.

Next, the method proceeds to step S120, as indicated in FIG. 4, a ring block B2 surrounding the original image IM1 is filled with a plurality of edge pixels PL of the original image IM1 by the pre-processing unit 120 to obtain a pre-processed image IM2.

The ring block B2 includes a plurality of corner blocks B21, B23, B25, B27 and a plurality of rectangular connection blocks B22, B24, B26, B28. The rectangular connection block B22 connects the corner block B21 and the corner block B23; the rectangular connection block B24 connects the corner block B23 and the corner block B25; the rectangular connection block B26 connects the corner block B25 and the corner block B27; the rectangular connection block B28 connects the corner block B27 and the corner block B21.

The edge pixels PL include a plurality of corner point pixels PL1, PL3, PL5, PL7 and a plurality of side pixels PL2, PL4, PL6, PL8. The side pixel PL2 is located between the corner point pixel PL1 and the corner point pixel PL3; the side pixel PL4 is located between the corner point pixel PL3 and the corner point pixel PL5; the side pixel PL6 is located between the corner point pixel PL5 and the corner point pixel PL7; the side pixel PL8 is located between the corner point pixel s PL7 and the corner point pixel s PL1.

The corner block B21 is filled with the corner point pixel PL1 of the original image IM1; the rectangular connection blocks B22 is filled with the side pixel PL2 of the original image IM1; the corner block B23 is filled with the corner point pixel PL3 of the original image IM1; the rectangular connection blocks B24 is filled with the side pixel PL4 of the original image IM1; the corner block B25 is filled with the corner point pixel PL5 of the original image IM1; the rectangular connection block B26 is filled with the side pixel PL6 of the original image IM1; the corner block B27 is filled with the corner point pixel PL7 of the original image IM1; the rectangular connection block B28 is filled with the edge pixel PL8 of the original image IM1. The above filling process increases the accuracy and speed of the out-painting process. In an embodiment, the filling process can be omitted.

Then, the method proceeds to step S130, the pre-processed image IM2 is cut into a plurality of to-be-processed images IM31, IM32, IM33, IM34 by the cutting unit 130. The to-be-processed images IM31, IM32, IM33, IM34 have a quantity of 4. The to-be-processed images IM31 includes the top left corner of the original image IM1 and the top left corner of the ring block B2; the to-be-processed images IM32 includes the top right corner of the original image IM1 and the top right corner of the ring block B2; the to-be-processed images IM33 includes the bottom right corner of the original image IM1 and the bottom right corner of the ring block B2; the to-be-processed images IM34 includes the bottom left corner of the original image IM1 and the bottom left corner of the ring block B2. The to-be-processed images IM31, IM32, IM33, IM34 substantially have the same size.

In an embodiment, the to-be-processed images IM31, IM32, IM33, IM34 include parts of the original image IM1 with identical sizes. In another embodiment, the to-be-processed images IM31, IM32, IM33, IM34 may include parts of the original image IM1 with different sizes.

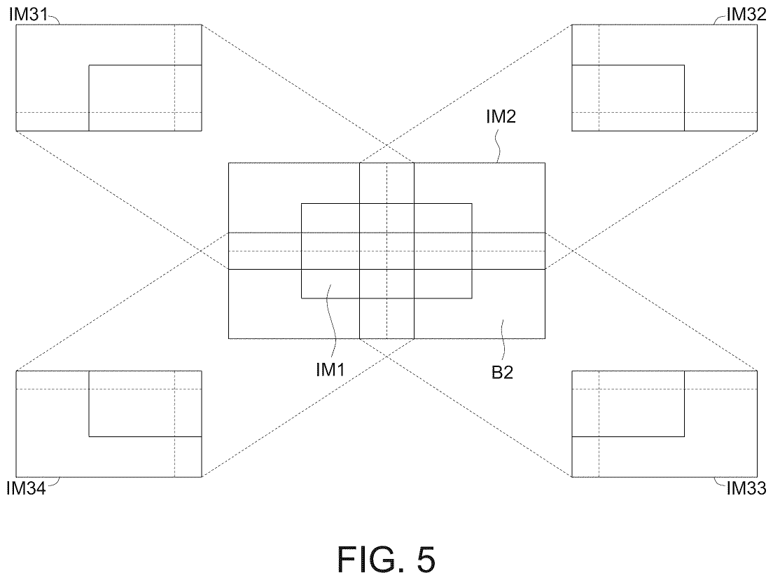

Referring to FIG. 5, the relationship between the pre-processed image IM2 and the to-be-processed images IM31, IM32, IM33, IM34 is exemplified. The to-be-processed images IM31, IM32, IM33, IM34 partially overlap at the edges for the convenience of frame stitching.

Then, the method proceeds to step S140, as indicated in FIG. 4, a plurality of masks MK41, MK42, MK43, MK44 are obtained by the mask unit 140 according to the to-be-processed images IM31, IM32, IM33, IM34. In each of the masks MK41, MK42, MK43, MK44, the pixels corresponding to 0 (slashed area) do not need to be out-painted, but the pixels corresponding to 1 (blank area) need to be out-painted. That is, the original image IM1 whose pixels correspond to 0 will be reserved, and only the ring block B2 whose pixels correspond to 1 needs to be out-painted.

Then, the method proceeds to step S150, as indicated in FIG. 4, the contents of a part of the ring block B2 in the to-be-processed images IM31, IM32, IM33, IM34 are individually out-painted by the expansion unit 150 according to the masks MK41, MK42, MK43, MK44 to obtain a plurality of painted images IM51, IM52, IM53, IM54. Since the to-be-processed images IM31, IM32, IM33, IM34 are out-painted using pipeline technology, the calculation resources and the memory resources will not be occupied at the same time.

In the step of out-painting the contents of a part of the ring block B2 in the to-be-processed images IM31, IM32, IM33, IM34, the contents are out-painted through positive prompt, and there is no need to employ negative prompt. That is, since negative prompt does not do much good in out-painting, only positive prompt will be employed, not only increasing out-painting speed but also maintaining accuracy level.

Then, the method proceeds to step S160, as indicated in FIG. 2, noise reduction is performed on the painted images IM51, IM52, IM53, IM54 by the noise reduction unit 160.

Then, the method proceeds to step S170, whether out-painting and noise reduction have been performed for a pre-determined number of times is determined. If yes, the method proceeds to step S180; otherwise, the method returns to step S150.

Then, the method proceeds to step S180, as indicated in FIG. 4, the painted images IM51, IM52, IM53, IM54 are stitched together by the stitching unit 180 to obtain an expanded image IM8. Since the to-be-processed images IM31, IM32, IM33, IM34 partially overlap at the edges, the painted images IM51, IM52, IM53, IM54 can be smoothly stitched without showing abrupt lines.

Then, the method proceeds to step S190, as indicated in FIG. 2, resolution adjustment is performed to the expanded image IM8 by the resolution adjustment unit 190 to comply with the required resolution level of the outputted image.

During the image out-painting process of the above embodiment, the original image IM1 is cut using pipeline technology, then the expansion unit 150 out-paints the cut images to obtain several painted images IM51, IM52, IM53, IM54, then the painted images are stitched together to form a large-sized expanded image IM8. Since the process of obtaining the painted images IM51, IM52, IM53, IM54 does not occupy calculation resources and memory resources at the same time, most electronic devices will be able to out-paint large-sized images.

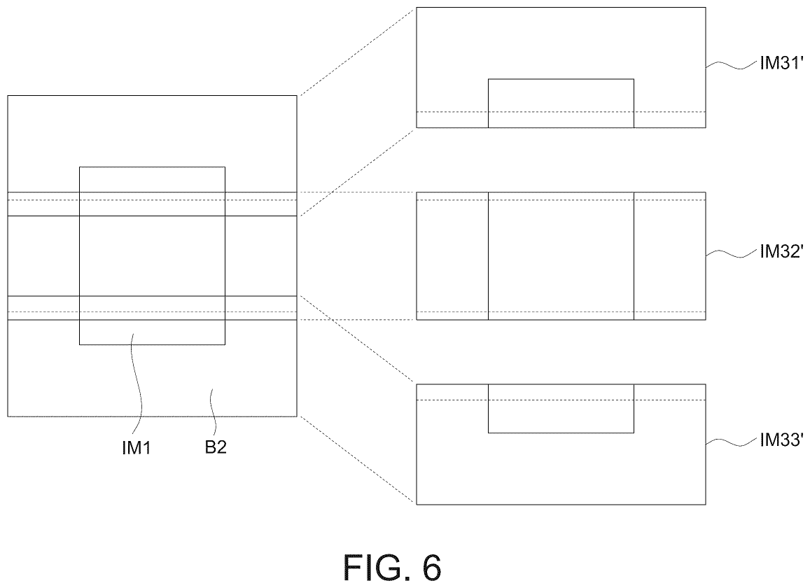

Referring to FIG. 6, another cutting method for the pre-processed image IM2 according to another embodiment is shown. In another embodiment, the pre-processed image IM2 can be cut into a plurality of to-be-processed images IM31′, IM32′, IM33′ by the cutting unit 130. The to-be-processed images IM31′, IM32′, IM33′ have a quantity of 3. The to-be-processed image IM31′ includes the upper part of the original image IM1 and the upper part of the ring block B2; the to-be-processed image IM32′ includes the middle part of the original image IM1 and the middle part of the ring block B2; the to-be-processed image IM33′ includes the lower part of the original image IM1 and the lower part of the ring block B2. The to-be-processed images IM31′, IM32′, IM33′ substantially have the same size.

In the present embodiment, the to-be-processed images IM31′, IM32′, IM33′ include parts of the original image IM1 with different sizes.

Distinctive features of some implementations or examples for implementing the present disclosure are disclosed above. Specific examples (such as numerals or designations disclosed above) are used in the descriptions of elements and configurations to simplify/illustrate some implementations of the present disclosure. These elements and configurations are exemplified for explanatory purpose only, not for limiting the scope of protection. Besides, some implementations of the present disclosure can repeat reference symbols and/or letters in various examples. The said repetition is for the purpose of simplicity and clarity only, not for specifying the relationship among various implementations and/or configurations.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. An image out-painting method, comprising:
providing an original image;
filling a ring block surrounding the original image with a plurality of edge pixels of the original image to obtain a pre-processed image;
cutting the pre-processed image into a plurality of to-be-processed images, each comprising a part of the original image and a part of the ring block;
obtaining a plurality of masks according to the to-be-processed images;
individually out-painting contents of the ring block in the to-be-processed images according to the masks to obtain a plurality of painted images; and
stitching the painted images together to obtain an expanded image.

2. The image out-painting method according to claim 1, wherein the ring block comprises a plurality of corner blocks and a plurality of rectangular connection blocks; the edge pixels comprise a plurality of corner point pixels and a plurality of side pixels; the rectangular connection blocks connect the corner blocks; the corner blocks are filled with the corner point pixels of the original image; the rectangular connection blocks are filled with the side pixels of the original image.

3. The image out-painting method according to claim 1, wherein the to-be-processed images substantially have identical sizes.

4. The image out-painting method according to claim 1, wherein the to-be-processed images comprise parts of the original image with identical sizes.

5. The image out-painting method according to claim 1, wherein the to-be-processed images comprise parts of the original image with different sizes.

6. The image out-painting method according to claim 1, wherein the to-be-processed images have a quantity of 4.

7. The image out-painting method according to claim 1, wherein the to-be-processed images partially overlap.

8. The image out-painting method according to claim 1, wherein in each of the masks, the pixels corresponding to 0 do not need to be out-painted, but the pixels corresponding to 1 need to be out-painted.

9. The image out-painting method according to claim 1, wherein in the step of out-painting the contents of the ring block in the to-be-processed images, the contents are out-painted through positive prompt.

10. The image out-painting method according to claim 1, further comprising:
performing noise reduction to the painted images.

11. The image out-painting method according to claim 1, further comprising:
performing resolution adjustment to the expanded image.

12. An image out-painting system, comprising:
an input unit used to provide an original image;
a pre-processing unit used to fill a ring block surrounding the original image with a plurality of edge pixels of the original image to obtain a pre-processed image;
a cutting unit used to cut the pre-processed image into a plurality of to-be-processed images, each comprising a part of the original image and a part of the ring block;
a mask unit used to obtain a plurality of masks according to the to-be-processed images;
an expansion unit used to individually out-paint contents of the ring block in the to-be-processed images according to the masks to obtain a plurality of painted images; and
a stitching unit used to stitch the painted images together to obtain an expanded image.

13. The image out-painting system according to claim 12, wherein the ring block comprises a plurality of corner blocks and a plurality of rectangular connection blocks; the edge pixels comprises a plurality of corner point pixels and a plurality of side pixels; the rectangular connection blocks connect the corner blocks; the pre-processing unit fills the corner blocks with the corner point pixels of the original image; the pre-processing unit fills the rectangular connection blocks with the side pixels of the original image.

14. The image out-painting system according to claim 12, wherein the to-be-processed images obtained by the cutting unit through cutting substantially have identical sizes.

15. The image out-painting system according to claim 12, wherein the to-be-processed images obtained by the cutting unit through cutting comprise parts of the original image with identical sizes.

16. The image out-painting system according to claim 12, wherein the to-be-processed images obtained by the cutting unit through cutting comprise parts of the original image with different sizes.

17. The image out-painting system according to claim 12, wherein the to-be-processed images have a quantity of 4.

18. The image out-painting system according to claim 12, wherein the to-be-processed images partially overlap.

19. The image out-painting system according to claim 12, wherein in each of the masks, the pixels corresponding to 0 do not need to be out-painted, but the pixels corresponding to 1 need to be out-painted.

20. The image out-painting system according to claim 12, wherein the expansion unit out-paints the contents through positive prompt.
